(19) United States
(12) Patent Application Publication
(10) Pub. No.: US 2018/0134921 A1
(43) Pub. Date: May 17, 2018

(54) PRESSURE SENSITIVE ADHESIVE SHEET, METHOD FOR PRODUCING THE SAME, AND PRESSURE SENSITIVE ADHESIVE SHEET MEMBER

(71) Applicant: FUJIFILM Corporation, Tokyo (JP)

(72) Inventors: Naoki NAKAMURA, Minami-ashigara-shi (JP); Takahiro NAKAZAWA, Minami-ashigara-shi (JP); Yoshihito HODOSAWA, Minami-ashigara-shi (JP); Masanori TAKASE, Minami-ashigara-shi (JP); Atsushi INADA, Minami-ashigara-shi (JP); Junichi SUGIYAMA, Minami-ashigara-shi (JP)

(73) Assignee: FUJIFILM Corporation, Tokyo (JP)

(21) Appl. No.: 15/869,951

(22) Filed: Jan. 12, 2018

Related U.S. Application Data
(63) Continuation of application No. PCT/JP2016/062625, filed on Apr. 21, 2016.

(30) Foreign Application Priority Data
Jul. 13, 2015 (JP) 2015-139465
Mar. 31, 2016 (JP) 2016-070694

(51) Int. Cl. C09J 7/38; B05D 1/36; B05D 3/04; B05D 5/10; C09J 183/04

(52) U.S. Cl. CPC C09J 7/38; B05D 1/36; C09J 2483/00; B05D 5/10; C09J 183/04; B05D 3/0413

(57) ABSTRACT

A pressure sensitive adhesive sheet includes a transparent sheet base material, a first pressure sensitive adhesive layer, and a second pressure sensitive adhesive layer, and a pressure sensitive adhesive strength by a pressure of 1 N/cm² or less is 0 N/25 mm. The first pressure sensitive adhesive layer includes a first silicone-based pressure sensitive adhesive and the second pressure sensitive adhesive layer has a second silicone-based pressure sensitive adhesive and a plurality of protrusions formed of a plurality of fine particles. A first sheet surface is a surface to adhere to an adherend. An average particle diameter of the fine particles is 2 μm or more and 15 μm or less and a coverage ratio of the first sheet surface with the fine particles is 10% or more and 70% or less.

### CROSS-REFERENCE TO RELATED APPLICATIONS

This application is a Continuation of PCT International Application No. PCT/JP2016/062625 filed on Apr. 21, 2016, which claims priority under 35 U.S.C § 119(a) to Japanese Patent Applications No. 2015-139465 filed on Jul. 13, 2015, and No. 2016-070694 filed on Mar. 31, 2016. The above application is hereby expressly incorporated by reference, in its entirety, into the present application.

### BACKGROUND OF THE INVENTION

### 1. Field of the Invention

The present invention relates to a pressure sensitive adhesive sheet, a method for producing the same, and a pressure sensitive adhesive sheet member.

### 2. Description of the Related Art

A pressure sensitive adhesive sheet that can adhere to an object to which the pressure sensitive adhesive sheet adheres (hereinafter, referred to as an adherend) by aligning and temporarily fixing the pressure sensitive adhesive sheet to the object and then applying strong pressure thereto has been known. As described above, a pressure sensitive adhesive sheet has adhesiveness performance according to applied pressure and is formed by applying an adhesive to the surface of a sheet-like base material. Various pressure sensitive adhesive sheets have been proposed.

For example, JP1996-325536A (JP-H08-325536A) proposes a pressure sensitive adhesive sheet in which a base material, an adhesive layer, and a release paper, which is a peelable support layer, are laminated. The adhesive layer is disposed on the base material and non-adhesive fine particles having an average particle diameter of 10 to 60 am are uniformly dispersed on the surface of the adhesive layer so as to protrude. The coverage ratio of the fine particles with respect to the surface area of the adhesive layer is set to about 3% to 30% and the fine particles are non-destructive under pressing pressure. In addition. JP1983-013682A (JP-S58-013682A) (corresponding to U.S. Pat. No. 4,556,595A) discloses a pressure sensitive adhesive sheet in which a base material, an adhesive layer, and a release paper are laminated, and fine particles are disposed on the surface or in the inside of the adhesive layer. In the pressure sensitive adhesive sheet disclosed in JP1983-013682A (JP-S58-013682A), the average particle diameter of the fine particles is most preferably set to 2 μm or less and thus the fine particles are not broken or crushed under pressing pressure at the time of causing the pressure sensitive adhesive sheet to adhere to an adherend with pressure.

In addition, JP2011-519977A (corresponding to US2009/246478A1) discloses a sheet in which a pressure sensitive adhesive layer formed of a pressure sensitive adhesive composition is provided in a part of one sheet surface. This pressure sensitive adhesive layer has pressure sensitive adhesiveness for causing sheets to adhere to each other in a pad formed by superimposing a plurality of sheets and causing the sheet peeled off from the pad to adhere to other materials with a pressure equal to or greater than a threshold pressure and includes non-pressure sensitive adhesive microspheres. Microspheres have an average particle diameter larger than the thickness of the pressure sensitive adhesive layer and are provided to protrude from the surface of the pressure sensitive adhesive layer. Further, JP2003-140376A (corresponding to US2004/197533A1) discloses a laminated film having pressure sensitive adhesiveness, which includes a transparent base material, and a transparent pressure sensitive adhesive layer provided on one surface of the base material. This laminated film has a release liner on the pressure sensitive adhesive layer and is used after peeling off the release liner. Fine roughness is provided on the surface of the pressure sensitive adhesive layer and at the time of completion of adherence of the pressure sensitive adhesive layer to an adherend, the roughness structure is eliminated.

In some cases, the pressure sensitive adhesive sheet is long and is provided with a pressure sensitive adhesive layer at the center in a width direction and thus the side ends are made thicker than the center of the pressure sensitive adhesive layer (for example, refer to JP2008-018614A and JP2008-110614A).

In the pressure sensitive adhesive sheets disclosed in JP1996-325536A (JP-H08-325536A) and JP1983-013682A (JP-S58-013682A), since the adhesive layer in a before-use state such as storage and/or transport adheres to other materials, a release paper is provided on the adhesive layer to prevent such adherence. Similar to the release paper, the release liner disclosed in JP2003-140376A also prevents the pressure sensitive adhesive layer in a before-use state from adhering to other materials. A release sheet, such as the release paper or the release liner, which is provided to prevent adherence and is peeled off in use, requires time and effort for peeling off the release sheet in a case of adherence to an adherend and inhibits an improvement in efficiency of work. In addition, the peeled-off release sheet requires a post-treatment of collection and/or disposal. Further, a space and/or weight for storage and/or transport for the pressure sensitive adhesive sheet provided with the release sheet is increased by the thickness of the release sheet. From this viewpoint, it is desirable that the pressure sensitive adhesive layer does not adhere to materials other than the adherend before use although the release sheet is not required. Further, considering the alignment and temporary fixing to the adherend and the like, a so-called pressure sensitive adhesive sheet having pressure sensitive adhesiveness (tackiness) is more preferable than an adhesive sheet having adhesiveness. In this viewpoint, while the laminated film disclosed in JP2003-140376A is a pressure sensitive adhesive sheet having a pressure sensitive adhesive layer, the non-pressure sensitive adhesiveness before use is not sufficient, and thus the release sheet is still provided. In addition, since the pressure sensitive adhesive layer disclosed in JP2011-519977A also adheres to other materials in a case of being in contact with other materials, a release sheet is required to distribute the sheets in an individual state. Even in the long pressure sensitive adhesive sheets disclosed in JP2008-018614A and JP2008-110614A, a release sheet is provided. Further, in recent years, there has been a demand for a pressure sensitive adhesive sheet having excellent transparency.

### SUMMARY OF THE INVENTION

An object of the present invention is to provide a pressure sensitive adhesive (tack) sheet having transparency and not requiring a release sheet, a method for producing the same, and a pressure sensitive adhesive sheet member which is a material for a pressure sensitive adhesive sheet.

In order to achieve the above object, a pressure sensitive adhesive sheet according to the present invention includes a transparent sheet base material, a first pressure sensitive adhesive layer, and a second pressure sensitive adhesive layer. The first pressure sensitive adhesive layer is provided on the sheet base material and includes a first silicone-based pressure sensitive adhesive. The second pressure sensitive adhesive layer forms one sheet surface with the first pressure sensitive adhesive layer being held between the sheet base material and the second pressure sensitive adhesive layer, and has a second silicone-based pressure sensitive adhesive and a plurality of protrusions formed of a plurality of fine particles. The fine particles have an average particle diameter in a range of 2 μm or more and 15 m or less. A coverage ratio of the one sheet surface with the fine particles is in a range of 10% or more and 70% or less. A pressure sensitive adhesive strength at the one sheet surface is 0 N/25 mm at a pressure of 1 N/cm² or less.

It is preferable that the first pressure sensitive adhesive layer does not contain fine particles. It is preferable that the first silicone-based pressure sensitive adhesive and the second silicone-based pressure sensitive adhesive are polydimethylsiloxanes.

It is preferable that a difference between a refractive index of the fine particle and a refractive index of the second silicone-based pressure sensitive adhesive is in a range of greater than 0 and 0.1 or less. It is preferable that a ratio T2/T1 of a thickness T2 of the second pressure sensitive adhesive layer with respect to a thickness T1 of the first pressure sensitive adhesive layer is in a range of 0.1 or more and 3 or less.

It is preferable that a mixed layer in which the first silicone-based pressure sensitive adhesive and the second silicone-based pressure sensitive adhesive are mixed is provided between the first pressure sensitive adhesive layer and the second pressure sensitive adhesive layer. It is preferable that a thickness of the mixed layer is at least 0.5 μm. It is preferable that a mass ratio of the first silicone-based pressure sensitive adhesive in the mixed layer is in a range of 10% by mass or more and 50% by mass or less.

A pressure sensitive adhesive sheet member according to the present invention includes a pressure sensitive adhesive portion and a pair of film thickness portions, and is long. The pressure sensitive adhesive portion is provided at a center in a width direction and is formed of the pressure sensitive adhesive sheet. The film thickness portions are provided at side ends in the width direction and have a thickness larger than a thickness from the one sheet surface in the pressure sensitive adhesive portion to a boundary between the first pressure sensitive adhesive layer and the sheet base material.

A method for producing a pressure sensitive adhesive sheet according to the present invention includes a coating step and a drying step. The coating step is a step of applying a first coating solution including a first organopolysiloxane and a solvent for the first organopolysiloxane and a second coating solution including a second organopolysiloxane, a solvent for the second organopolysiloxane, and a plurality of fine particles having an average particle diameter in a range of 2 μm or more and 15 μm or less to a transparent sheet base material such that a flow of the first coating solution and a flow of the second coating solution are superimposed to form a coating film in which the second coating solution is superimposed on the first coating solution. The drying step is a step of drying the coating film.

It is preferable that the first organopolysiloxane and the second organopolysiloxane are curable polydimethylsiloxanes that are crosslinked by heating, and the drying step includes a crosslinking step of respectively crosslinking the first organopolysiloxane and the second organopolysiloxane by heating the coating film.

It is preferable that there is a difference between a proportion of the solvent in the first coating solution and a proportion of the solvent in the second coating solution.

The pressure sensitive adhesive sheet and the pressure sensitive adhesive sheet member of the present invention have excellent transparency and the pressure sensitive adhesive sheet and the pressure sensitive adhesive sheet member do not require a release sheet. In addition, according to the method for producing a pressure sensitive adhesive sheet of the present invention, it is possible to obtain a pressure sensitive adhesive sheet having excellent transparency and not requiring a release sheet.

### BRIEF DESCRIPTION OF THE DRAWINGS

FIG. 1 is a cross-sectional view of a pressure sensitive adhesive sheet.

FIG. 2 is a view illustrating a method for obtaining a coverage ratio of a first sheet surface with fine particles.

FIG. 3 is a view illustrating protrusions of the first sheet surface.

FIG. 4 is a graph showing a relationship between pressure applied to the pressure sensitive adhesive sheet in a thickness direction and a pressure sensitive adhesive strength of the pressure sensitive adhesive sheet.

FIG. 5 is a schematic view of a production facility for a pressure sensitive adhesive sheet member.

FIG. 6 is a view illustrating an end portion of a cross section of a pressure sensitive adhesive sheet member along a width direction.

FIG. 7 is a schematic view of a knurling device.

FIG. 8 is a development view illustrating a circumferential surface of a first knurling roller.

FIG. 9 is a view illustrating protrusions of the first knurling roller.

FIG. 10 is a cross-sectional view of a pressure sensitive adhesive sheet.

### DESCRIPTION OF THE PREFERRED EMBODIMENTS

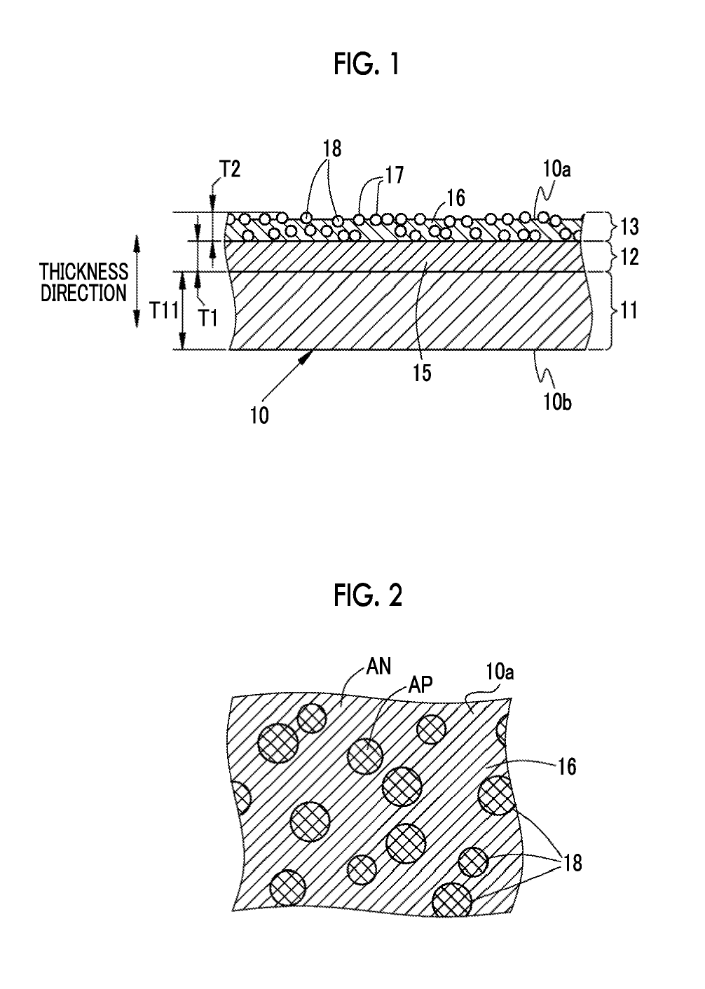

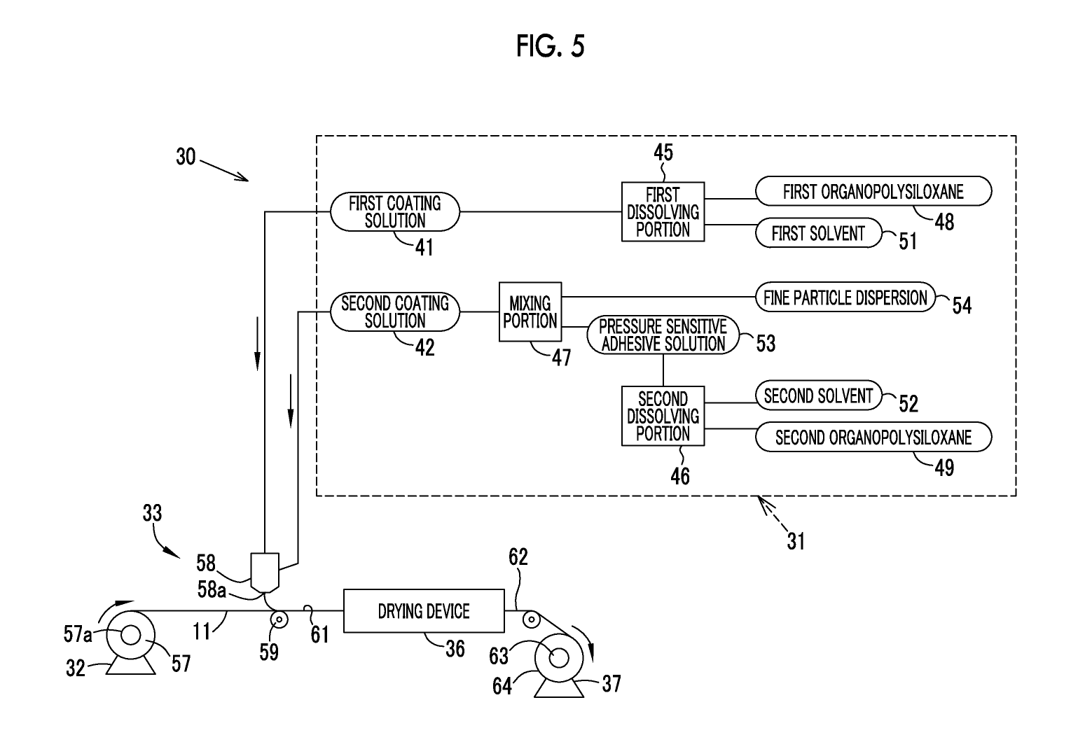

In FIG. 1, a pressure sensitive adhesive (tack) sheet 10 embodied according to the present invention includes a sheet base material 11, a first pressure sensitive adhesive layer 12 disposed on one surface of the sheet base material 11 (hereinafter, referred to as a base material surface), and a second pressure sensitive adhesive layer 13 provided on the first pressure sensitive adhesive layer 12 in a close contact state. The pressure sensitive adhesive sheet 10 is obtained by cutting out a long pressure sensitive adhesive sheet member 62 (refer to FIG. 5), which will be described later, into a sheet. One sheet surface (hereinafter, referred to as a first sheet surface) 10a constituted of the second pressure sensitive adhesive layer 13 is a surface to adhere to an object to which the pressure sensitive adhesive sheet adheres (hereinafter, referred to as an adherend). In addition, the sheet base material 11 forms the other sheet surface (hereinafter, referred to as a second sheet surface) 10b and by pressing the side close to the second sheet surface 10b, that is, by applying pressure to the side close to the second sheet surface, the pressure sensitive adhesive sheet 10 adheres to the adherend.

The pressure sensitive adhesive sheet 10 is used for, for example, a cover film and a marking film of analytical instruments and the like. For example, in a case of using the pressure sensitive adhesive sheet for a cover film, the base material surface of the sheet base material 11 which becomes the second sheet surface 10b of the pressure sensitive adhesive sheet 10 is subjected to antifouling treatment in advance. In addition, for example, in a case of using the pressure sensitive adhesive sheet for a marking film, the base material surface of the sheet base material 11 which becomes the second sheet surface 10b of the pressure sensitive adhesive sheet 10 is subjected to printing in advance or decoration is applied to the base material surface in advance.

In a case where the pressure applied to the pressure sensitive adhesive sheet 10 in a thickness direction is 1 N/cm² or less, the pressure sensitive adhesive strength is set to 0 N/25 mm and the pressure sensitive adhesive sheet does not adhere to an adherend. The pressure described below means pressure applied in the thickness direction. A pressure of 1 N/cm² or less is referred to as a first pressure below. In a case where the first pressure is applied to the pressure sensitive adhesive sheet 10, the pressure sensitive adhesive strength is more preferably 0.4 N/25 mm or less, and even more preferably 0.04 N/25 mm or less. In the embodiment, the pressure sensitive adhesive strength is set to 0.00 N/25 mm. As described above, in the embodiment, the pressure sensitive adhesive strength is calculated to two decimal places as a significant digit. Accordingly, the pressure sensitive adhesive strength being “0 N/25 mm” means that 0 N/25 mm is obtained by rounding off to the last term calculated by the measurement method in a case where the measurement limit for measuring the pressure sensitive adhesive strength is one decimal place or less.

The pressure sensitive adhesive strength is obtained in accordance with Japanese Industrial Standard JIS Z0237, and the above-mentioned significant digit in the embodiment is based on the measurement limit in the calculation method. In the embodiment, first, a sample for measurement having a size of 0.025 m×0.1 m is cut out from the pressure sensitive adhesive sheet 10. The sample is placed on a stand in a state in which the first sheet surface 10a is directed upward. The first sheet surface 10a is coated with a polypropylene film with a thickness of 12 μm (ALPHAN E-501, manufactured by Oji F-Tex Co., Ltd.) which has been cut into a predetermined size (having a size of 0.025 m×0.13 m), and the sample is pressed using a dedicated rubber roll (IMC-B2, manual tape pressing roll, manufactured by Imoto Machinery Co., Ltd.) by a method in accordance with JIS Z0237. Then, a load in a case where the polypropylene film is peeled off from the sample is set to pressure sensitive adhesive strength. The measurement of the load is performed by a digital force gauge (FGP-5, manufactured by NIDEC-SHIMPO Corporation) caused to adhere to a motorized horizontal type digital force gauge stand (FGS-50XB, manufactured by NIDEC-SHIMPO Corporation).

In a case of applying a pressure in a range of greater than 1 N/cm² and 7 N/cm² or less to the pressure sensitive adhesive sheet 10, the pressure sensitive adhesive strength is set to be in a range of greater than 0 N/25 mm and 5 N/25 mm or less. In addition, in a case of applying a pressure in a range of greater than 7 N/cm² and 20 N/cm² or less to the pressure sensitive adhesive sheet 10, the pressure sensitive adhesive strength is set to be in a range of greater than 5 N/25 mm and 10 N/25 mm or less. A pressure in a range of greater than 1 N/cm² and 7 N/cm² or less is referred to as a second pressure and a pressure in a range of greater than 7 N/cm² and 20 N/cm² or less is referred to as a third pressure. In a case where the second pressure and the third pressure are applied, the respective pressure sensitive adhesive strengths are exhibited by application of each of the second pressure and the third pressure and are maintained after the second pressure and the third pressure are respectively released.

The sheet base material 11 is the sheet main body of the pressure sensitive adhesive sheet 10 and is transparent. The sheet base material 11 of the embodiment is formed of polyethylene terephthalate (hereinafter, referred to as PET) and may include additives. Examples of the additives include a plasticizer and/or an ultraviolet absorbent. The material for forming the sheet base material 11 is not limited to PET. The sheet base material 11 may be formed of polyvinyl chloride (hereinafter, referred to as PVC), polyethylene (hereinafter, referred to as PE), or the like, and in this case, the sheet base material may also include various additives described above.

A thickness T11 of the sheet base material 11 is appropriately set according to applications and is not particularly limited. The thickness T11 of the sheet base material 11 in a case of forming the sheet base material using PET, PVC, PE, or the like is set to be, for example, in a range of 12 μm or more and 350 μm or less, and the thickness of the sheet base material in the embodiment is 40 μm.

The first pressure sensitive adhesive layer 12 and the second pressure sensitive adhesive layer 13 have a pressure sensitive adhesive function (including a function of not providing pressure sensitive adhesiveness, a so-called non-pressure sensitive adhesive function) according to a case of handling the pressure sensitive adhesive sheet 10. The handling case includes a so-called before-use case such as storage and/or transport, a preparation case such as temporary fixing and/or re-adherence for confirming an adhering position with respect to an adherend, and a so-called use case in an adhering operation to a confirmed adhering position and/or in a neglected state (adhering state) after the adhering operation. The first pressure sensitive adhesive layer 12 is provided to exhibit the pressure sensitive adhesive performance in the use case among the handling cases and specifically provided to achieve rapid adherence to an adherend and hold the adhering state for a desired period of time.

The first pressure sensitive adhesive layer 12 is formed of a first silicone-based pressure sensitive adhesive 15 and thus in a case of applying the third pressure, the pressure sensitive adhesive strength of the pressure sensitive adhesive sheet 10 is reliably set to be in a range of greater than 5 N/25 mm and 10 N/25 mm or less in cooperation with the second pressure sensitive adhesive layer 13. The first pressure sensitive adhesive layer 12 does not contain fine particles and thus in a case of applying the third pressure, the pressure sensitive adhesive strength of the pressure sensitive adhesive sheet 10 is more reliably set to be in a range of greater than 5 N/25 mm and 10 N/25 mm or less. The first silicone-based pressure sensitive adhesive 15 is transparent.

As the first silicone-based pressure sensitive adhesive 15 and a second silicone-based pressure sensitive adhesive 16, which will be described later, organopolysiloxane in which an organic group is bonded to a siloxane bond which is a main skeleton is preferable, polydimethylsiloxane is more preferable, and among these, a curing type polydimethylsiloxane is even more preferable. The curing type polydimethylsiloxane is obtained by crosslinking a curable polydimethylsiloxane having a property in which polydimethylsiloxane is crosslinked (cured) by heating. The curing type polydimethylsiloxane is particularly preferably any one of a peroxide curing type polydimethylsiloxane or an addition reaction type polydimethylsiloxane, and in the embodiment, an addition reaction type silicone-based pressure sensitive adhesive is used. The peroxide curing type dimethylsiloxane is obtained by crosslinking a peroxide curable polydimethylsiloxane, which will be described later, by heating using a crosslinking agent such as benzoyl peroxide and the temperature at heating for crosslinking is, for example, 150° c. or higher. The addition reaction type polydimethylsiloxane is obtained by crosslinking an addition reaction type polydimethylsiloxane, which will be described later, by heating using a catalyst such as platinum.

The first silicone-based pressure sensitive adhesive 15 and the second silicone-based pressure sensitive adhesive 16 may be formed of the same substance or may be formed of different substances from each other. However, from the viewpoint of further enhancing the adhesion between the first pressure sensitive adhesive layer 12 and the second pressure sensitive adhesive layer 13 and from the viewpoint of further enhancing the transparency of the pressure sensitive adhesive sheet 10, it is preferable that the first silicone-based pressure sensitive adhesive 15 and the second silicone-based pressure sensitive adhesive 16, which will be described later, are formed of the same substance. In a case where the first silicone-based pressure sensitive adhesive 15 and the second silicone-based pressure sensitive adhesive 16 are formed of different substances from each other, from the viewpoint of enhancing the transparency of the pressure sensitive adhesive sheet 10, the smaller the difference in refractive index is, the more preferable it is, and the difference in refractive index is preferably within 0.1.

The addition reaction type silicone-based pressure sensitive adhesive preferably has a peak in a range in which the average molecular weight is 3000 or more and 800000 or less, and in the embodiment, the addition reaction type silicone-based pressure sensitive adhesive has peaks at two places of 5000 and 500000. In the addition reaction type silicone-based pressure sensitive adhesive, the terminal of the polydimethylsiloxane as organopolysiloxane is a vinyl group (H₂C═CH—).

The average molecular weight refers to a weight-average molecular weight and is obtained by a gel permeation chromatography (GPC) method in terms of polystyrene. In the embodiment, the average molecular weight is obtained by using HLC-8320 GPC, manufactured by Tosoh Corporation, toluene as a solvent, and LF-804 (830 mmφ×300 mm), manufactured by SHOKO Co., Ltd., as a column.

The first pressure sensitive adhesive layer 12 may include other substances in addition to the first silicone-based pressure sensitive adhesive 15, but it is preferable that the first pressure sensitive adhesive layer is constituted of only the first silicone-based pressure sensitive adhesive 15. However, in the case where the first silicone-based pressure sensitive adhesive 15 is an addition reaction type silicone-based pressure sensitive adhesive obtained through crosslinking using a catalyst as in the embodiment, the catalyst may be included in the pressure sensitive adhesive layer for promoting a curing reaction in the crosslinking.

A thickness T1 of the first pressure sensitive adhesive layer 12 is set to 20 μm in the embodiment but the thickness is not limited thereto. The thickness T1 of the first pressure sensitive adhesive layer 12 is set according to the required pressure sensitive adhesive strength in use and the required pressure sensitive adhesive strength is determined in consideration of the material and/or the surface state of the adherend, environments for a long period of time of adherence, and the like.

The second pressure sensitive adhesive layer 13 is provided to exhibit the pressure sensitive adhesive performance according to each case in all handling cases of before-use, preparation, and use, and is provided to exhibit the pressure sensitive adhesive performance mainly in the before-use and preparation cases among these cases. Specifically, the second pressure sensitive adhesive layer is provided to prevent adherence of the pressure sensitive adhesive sheet to materials other than an adherend in the before-use case, to cause the pressure sensitive adhesive sheet to adhere to the adherend in a re-adherable state in the preparation case, to causes the pressure sensitive adhesive sheet to rapidly adhere to the adherend in the use case, and to hold the adhering state for a desired period of time.

The second pressure sensitive adhesive layer 13 has the second silicone-based pressure sensitive adhesive 16, and a plurality of protrusions 17 formed on the first sheet surface 10a by fine particles 18, and the first sheet surface 10a of the pressure sensitive adhesive sheet 10 is formed by the second silicone-based pressure sensitive adhesive 16 and the plurality of protrusions 17. Thus, the pressure sensitive adhesive sheet 10 reliably exhibits a pressure sensitive adhesive strength of 0 N/25 mm at the first pressure, more reliably exhibits a pressure sensitive adhesive strength in a range of greater than 0 N/25 mm and 5 N/25 mm or less at the second pressure, and exhibits a pressure sensitive adhesive strength in a range of greater than 5 N/25 mm and 10 N/25 mm or less at the third pressure in cooperation with the first pressure sensitive adhesive layer 12. The second silicone-based pressure sensitive adhesive 16 has both a pressure sensitive adhesive function with respect to the adherend and a binder function of holding the fine particles 18, and is transparent.

Since the fine particles 18 forming each protrusion 17 are spherical in the example, the protrusions 17 are formed in a spherical crown shape. The plurality of fine particles 18 have an average particle diameter in a range of 2 μm or more and 15 μm or less. The fine particle 18 may be a primary particle or a secondary particle formed by aggregating primary particles, and in a case where the fine particle is a secondary particle, the average particle diameter of the secondary particles may be in the above range. The average particle diameter is more preferably in a range of 5 μm or more and 15 μm or less and even more preferably in a range of 10 μm or more and 15 μm or less.

The average particle diameter of the plurality of fine particles 18 is calculated by the following method. First, a sample is prepared by cutting out a part from the pressure sensitive adhesive sheet 10, the cut sample is subjected to freezing (cryo) treatment, and then a long slice is prepared by a microtome. The cross section of the prepared slice is observed with an ultrahigh resolution field emission type scanning electron microscope (S-5500, manufactured by Hitachi High-Technologies Corporation), the particle diameters of arbitrarily extracted 100 fine particles are receptively obtained, and an average value of these particle diameter values is used as the average particle diameter of the fine particles 18.

The fine particle 18 is harder than the second silicone-based pressure sensitive adhesive 16. Herein, the hardness can be quantitatively determined by measuring the pressure of the respective fine particle 18 and second silicone-based pressure sensitive adhesive 16 in a case where the fine particle and the second silicone-based pressure sensitive adhesive are respectively compressed and plastically deformed. In the embodiment, the compression and pressure measurement is carried out by using a micro compression testing machine MCTM-500, manufactured by Shimadzu Corp. In a case where the hardness of the fine particle 18 is set to HP (unit; MPa), and the hardness of the second silicone-based pressure sensitive adhesive 16 is set to HA2 (unit; MPa), a difference in hardness obtained by HP−HA2 is preferably at least 10 MPa.

In a case where the refractive index of the fine particle 18 is set to NP, and the refractive index of the second silicone-based pressure sensitive adhesive 16 is set to NA2, a difference in refractive index obtained by |NP−NA2| is preferably in a range of more than 0 and 0.1 or less, more preferably in a range of 0.01 or more and 0.07 or less, and even more preferably in a range of 0.01 or more and 0.03 or less. In the embodiment, the above-mentioned addition reaction type silicone-based pressure sensitive adhesive (having a refractive index of 1.43) is used as the second silicone-based pressure sensitive adhesive 16 and fine particles (having a refractive index of 1.42) consisting of silicone are used as the fine particles 18. Thus, the difference in refractive index is 0.01.

The fine particles 18 are fine particles consisting of silicone as described above in the embodiment and are secondary particles. For example, as the fine particles consisting of silicone, TOSPEARL (registered trademark) (manufactured by Momentive Performance Materials Japan LLC) having a structure of crosslinked silicone consisting of methylsilsesquioxane (CH₃SiO_{1.5}), KMP-590 and X-52-1621 (manufactured by Shin-Etsu Chemical Co., Ltd.), and the like may be used. The material constituting the fine particles 18 is not limited to silicone and the individual fine particles 18 may be constituted of a so-called composite material, which is a material constituted of different substances from each other. Examples of materials other than silicone include silica (silicon dioxide), acrylic resin, and glass. In addition, for the fine particles 18, a plurality of different constituting materials may be used in combination.

Some of the plurality of fine particles 18 form the first sheet surface 10a together with the second silicone-based pressure sensitive adhesive 16, and others are embedded in the second silicone-based pressure sensitive adhesive 16 and scattered in the second pressure sensitive adhesive layer 13. The mass of the fine particles 18 in the second pressure sensitive adhesive layer 13 is preferably in a range of 10 or more and 50 or less in a case where the total mass of the second pressure sensitive adhesive layer 13 is set to 100. Regarding the mass of the fine particles 18 in the second pressure sensitive adhesive layer 13, it is preferable that as the average particle diameter of the fine particles 18 decreases, the mass increases in the above range, and as the average particle diameter increases, the mass decreases in the above range.

In the embodiment, as the second silicone-based pressure sensitive adhesive 16, the same silicone-based pressure sensitive adhesive as the first silicone-based pressure sensitive adhesive 15 of the first pressure sensitive adhesive layer 12 is used. Therefore, the boundary between the first pressure sensitive adhesive layer 12 and the second pressure sensitive adhesive layer 13 is not visually recognized as a line in the cross section unlike FIG. 1. However, in the thickness direction, the first pressure sensitive adhesive layer 12 is recognized as a region including the fine particles 18, and the second pressure sensitive adhesive layer 13 is recognized as a region not including the fine particles 18. Thus, in FIG. 1, for convenience of description, the boundary between the first pressure sensitive adhesive layer 12 and the second pressure sensitive adhesive layer 13 is shown. In this manner, the boundary between the first pressure sensitive adhesive layer 12 and the second pressure sensitive adhesive layer 13 is determined as a boundary of a region in which whether or not the fine particles 18 are present in the thickness direction depending on the first silicone-based pressure sensitive adhesive 15 and the second silicone-based pressure sensitive adhesive 16 to be used.

The second pressure sensitive adhesive layer 13 may include other substances in addition to the second silicone-based pressure sensitive adhesive 16 and the fine particles 18, but it is preferable that the second pressure sensitive adhesive layer is constituted of only the second silicone-based pressure sensitive adhesive 16 and the fine particles 18. However, as in the embodiment, in the case where the second silicone-based pressure sensitive adhesive 16 is an addition reaction type silicone-based pressure sensitive adhesive obtained through crosslinking using a catalyst, the catalyst may be included to promote the curing reaction in the crosslinking.

The thickness T2 of the second pressure sensitive adhesive layer 13 is 20 μm in the embodiment but is not limited thereto. The sum of the thickness T1 of the first pressure sensitive adhesive layer 12 and the thickness T2 of the second pressure sensitive adhesive layer 13 is preferably in a range of 5 μm or more and 150 μm or less. In a case where the sum of the thickness T1 of the first pressure sensitive adhesive layer 12 and the thickness T2 of the second pressure sensitive adhesive layer 13 is 5 μm or more, compared to a case where the sum of the thickness of the first pressure sensitive adhesive layer and the thickness of the second pressure sensitive adhesive layer is less than 5 μm, while the pressure sensitive adhesive strength by the first pressure is being maintained at 0 N/25 mm or less, the pressure sensitive adhesive strength by the third pressure is more reliably set to be greater than 5 N/25 mm. In addition, in a case where the sum of the thickness T1 of the first pressure sensitive adhesive layer 12 and the thickness T2 of the second pressure sensitive adhesive layer 13 is 150 μm or less, compared to a case where the sum of the thickness of the first pressure sensitive adhesive layer and the thickness of the second pressure sensitive adhesive layer is greater than 150 μm, the pressure sensitive adhesive strength by the third pressure is more reliably suppressed to 10 N/25 mm or less.

A ratio T2/T1 of the thickness T2 of the second pressure sensitive adhesive layer 13 with respect to the thickness T1 of the first pressure sensitive adhesive layer 12 is preferably set to be in a range of 0.1 or more and 3 or less, and is 1 in the embodiment. The ratio T2/T1 of the thickness T2 of the second pressure sensitive adhesive layer 13 with respect to the thickness T1 of the first pressure sensitive adhesive layer 12 is more preferably set to be in a range of 0.3 or more and 2.0 or less and even more preferably set to be in a range of 0.6 or more and 1.2 or less.

In FIG. 2, as the first sheet surface 10a is viewed in the vertical direction thereof, a covered region AP of the first sheet surface 10a which is covered by the fine particles 18 is indicated by cross-hatching and an non-covered region AN excluding the covered region AP is indicated by hatching with a parallel line. The area of the covered region AP is the sum of the areas of the regions covered by each of the plurality of fine particles 18 and is set to S1. In addition, the area of the non-covered region AN is set to S2. A coverage ratio RC of the first sheet surface 10a by the fine particles 18 is obtained by (S1/S2)×100 and is in a range of 10% or more and 70% or less. The coverage ratio RC is more preferably in a range of 30% or more and 70% or less and even more preferably in a range of 40% or more and 70% or less.

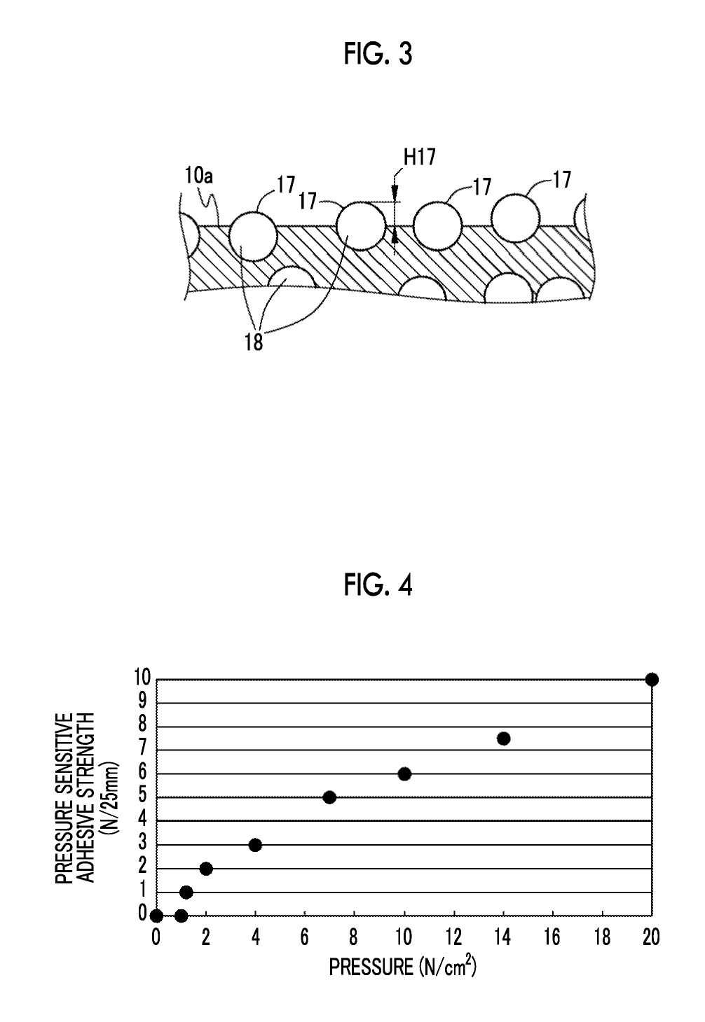

As shown in FIG. 3, the height from the first sheet surface 10a consisting of the second silicone-based pressure sensitive adhesive 16 to the top portion of the protrusion 17 in the first sheet surface 10a (hereinafter, referred to as protrusion height) H17 is not uniform. As the protrusion height H17 increases, the inclination of a graph in a case plots are connected with a line in FIG. 4 referred to in the following description decreases.

The effect of the above configuration will be described. As shown in FIG. 4, in the pressure sensitive adhesive sheet 10, the pressure sensitive adhesive strength by the first pressure is set to 0 N/25 mm and thus the pressure sensitive adhesive sheet is prevented from adhering to materials other than an adherend in the before-use case among the handling cases of the pressure sensitive adhesive sheet 10. In addition, since the pressure sensitive adhesive sheets 10 are prevented from adhering to each other, for example, a predetermined number of sheets can be pulled out from a sheet group in which a plurality of the pressure sensitive adhesive sheets 10 are laminated. In this manner, the pressure sensitive adhesive sheet 10 is prevented from adhering to other materials particularly in the before-use case without providing a release sheet to the first sheet surface 10a. Accordingly, the pressure sensitive adhesive sheet 10 is not required to have a release sheet. The data of the pressure sensitive adhesive strength shown in FIG. 4 is values obtained as significant digits of two decimal places as described above. However, in order to facilitate clear understanding, each plot is largely exaggerated and drawn. In this manner, the size of the plot in FIG. 4 is determined without consideration of an error. In consideration of an assumed atmosphere environment, the smaller the pressure sensitive adhesive strength by the first pressure is, the more preferable it is. In the embodiment, as described above, the pressure sensitive adhesive strength is 0.00 N/25 mm and is very small. Thus, for example, even in a case where the pressure sensitive adhesive sheet is left in an atmosphere environment at a high temperature and a high humidity, a non-pressure sensitive adhesive function, which does not require a release sheet, is maintained.

In the pressure sensitive adhesive sheet 10, since the pressure sensitive adhesive strength by the second pressure is set to be in a range of greater than 0 N/25 mm and 5 N/25 mm or less, the workability is good in the above-mentioned preparation case of the handling cases. Specifically, since the pressure sensitive adhesive strength by the second pressure is greater than 0 N/25 mm, the pressure sensitive adhesive sheet 10 is pressed with a small force from the side close to the second sheet surface 10b and thus is temporarily fixed. In addition, since the pressure sensitive adhesive strength by the second pressure is set to be in a range of 5 N/25 mm or less, the temporarily fixed pressure sensitive adhesive sheet 10 can be peeled off and re-adhere to an adherend with a small force.

Since the pressure sensitive adhesive strength by the third pressure is set to be in a range of greater than 5 N/25 mm and 10 N/25 mm or less, the pressure sensitive adhesive sheet 10 reliably adheres to an adherend by pressing the second sheet surface 10b at the time of temporary fixing with a strong force particularly in the use case of the handling cases. In addition, even in a case where the applied third pressure is released after adherence, the adhering state of the pressure sensitive adhesive sheet 10 is reliably maintained for a long period of time. Further, since the pressure sensitive adhesive strength by the third pressure is set to 10 N/25 mm or less, even in a case where the pressure sensitive adhesive sheet 10 is peeled off after the adhering state is maintained for a long period of time, cohesion failure of the first silicone-based pressure sensitive adhesive 15 and the second silicone-based pressure sensitive adhesive 16 does not occur and the pressure sensitive adhesives do not remain on the adherend.

Under the first pressure, the protrusions 17 protruding from the first sheet surface 10a function as spacers with other materials in contact with the second silicone-based pressure sensitive adhesive 16 and first sheet surface 10a, and the coverage ratio RC of the fine particles 18 in the first sheet surface 10a is set to be in a range of 10% or more and 70% or less. Since the protrusions 17 are formed and the coverage ratio RC is 10% or more, the second silicone-based pressure sensitive adhesive 16 is not in contact with other materials by the spacer function of the protrusions 17 at the first pressure, and thus a pressure sensitive adhesive strength of 0 N/25 mm is reliably exhibited. Therefore, the pressure sensitive adhesive sheet 10 is less likely to adhere to other materials, for example, materials other than an adherend in the before-use case without a release sheet. In addition, since the protrusions 17 are formed and the coverage ratio RC is in a range of 10% or more and 70% or less, at the second pressure, some of the plurality of fine particles 18 are embedded in the second silicone-based pressure sensitive adhesive 16 and the second silicone-based pressure sensitive adhesive 16 of the first sheet surface 10a is partially in contact with an adherend and most of the plurality of fine particles 18 protrude from the first sheet surface 10a. Thus, in the pressure sensitive adhesive sheet 10, a pressure sensitive adhesive strength in a range of greater than 0 N/25 mm and 5 N/25 mm or less is more reliably exhibited. As described above, the pressure sensitive adhesive sheet 10 adheres to an adherend in a re-adherable state in cooperation of the fine particles 18 and the second silicone-based pressure sensitive adhesive 16 at the second pressure. In addition, since the coverage ratio RC is 70% or less, at the third pressure, most or all of the fine particles 18 forming the protrusions 17 are embedded in the second silicone-based pressure sensitive adhesive 16 and the second silicone-based pressure sensitive adhesive 16 is in close contact with an adherend. Then, in the pressure sensitive adhesive sheet 10, a pressure sensitive adhesive strength in a range of greater than 5 N/25 mm and 10 N/25 mm or less is more reliably exhibited.

Since the average particle diameter of the plurality of fine particles 18 is 2 pun or more, even with the application of the first pressure, the second silicone-based pressure sensitive adhesive 16 is reliably prevented from adhering to other materials and the pressure sensitive adhesive strength is suppressed to 0 N/25 mm. In a case where the second pressure is applied, the second silicone-based pressure sensitive adhesive 16 exposed from the first sheet surface 10a is partially in contact with an adherend, the pressure sensitive adhesive strength is suppressed in a range of greater than 0 N/25 mm and 5 N/25 mm or less. In addition, since the average particle diameter is 15 m or less, the haze of the pressure sensitive adhesive sheet 10 is suppressed to a low level.

The fine particles 18 is harder than the second silicone-based pressure sensitive adhesive 16 and thus even in a case where pressure is applied to the pressure sensitive adhesive sheet 10 in the thickness direction, the fine particles are embedded in the second silicone-based pressure sensitive adhesive 16 without destruction. Thus, since the fine particles 18 are embedded in the second silicone-based pressure sensitive adhesive 16 in a nondestructive state under the second pressure, a reduction in the pressure sensitive adhesive strength caused by destruction of the fine particles 18 is prevented and the pressure sensitive adhesive strength at the third pressure is more reliably set to be in a range of greater than 5 N/25 mm and 10 N/25 mm or less even after the subsequent re-adherence.

Since the difference between the refractive index of the fine particle 18 and the refractive index of the second silicone-based pressure sensitive adhesive 16 is set to be in a range of greater than 0 and 0.1 or less, the haze of the pressure sensitive adhesive sheet 10 is suppressed to a low level and thus the pressure sensitive adhesive sheet 10 has further excellent transparency.

Since the fine particles 18 are scattered in the second pressure sensitive adhesive layer 13, in a case where the second pressure is applied, the pressure sensitive adhesive strength is less likely to be greater than 5 N/25 mm and in a case where the pressure sensitive adhesive sheet 10 is peeled off from an adherend after being used for a long period of time, the first silicone-based pressure sensitive adhesive 15 and the second silicone-based pressure sensitive adhesive 16 are stripped off without remaining on the adherend. The effect thereof is more reliably obtained by setting the mass of the fine particles 18 in the second pressure sensitive adhesive layer 13 to be in a range of 10 or more and 50 or less in a case where the total mass of the second pressure sensitive adhesive layer 13 is 100.

Since the sum of the thickness T1 of the first pressure sensitive adhesive layer 12 and the thickness T2 of the second pressure sensitive adhesive layer 13 is set to 5 μm or more, compared to a case where the sum of the thickness of the first pressure sensitive adhesive layer and the thickness of the second pressure sensitive adhesive layer is less than 5 μm, the pressure sensitive adhesive strength by the third pressure is more reliably set to be greater than 5 N/25 mm and thus the pressure sensitive adhesive sheet adheres to an adherend with a sufficient pressure sensitive adhesive strength in the use case. In addition, since the sum of the thickness T1 of the first pressure sensitive adhesive layer 12 and the thickness T2 of the second pressure sensitive adhesive layer 13 is 150 μm or less, compared to a case where the sum of the thickness of the first pressure sensitive adhesive layer and the thickness of the second pressure sensitive adhesive layer is less than 150 μm, the pressure sensitive adhesive strength by the third pressure is more reliably suppressed to 10 N/25 mm or less and even in a case where the pressure sensitive adhesive sheet 10 is peeled off after the adhering state is maintained for a long period of time, the pressure sensitive adhesives do not remain on the adherend.

The ratio T2/T1 of the thickness T2 of the second pressure sensitive adhesive layer 13 with respect to the thickness T1 of the first pressure sensitive adhesive layer 12 is preferably set to be in a range of 0.1 or more and 3 or less. By setting the ratio T2/T1 in this range, the pressure sensitive adhesive strength by each of the first pressure, the second pressure, and the third pressure is more reliably exhibited and haze is suppressed. Thus, sufficient transparency is more reliably exhibited. Specifically, in a case where T2/T1 is 0.1 or more, compared to a case where the ratio is less than 0.1, while the pressure sensitive adhesive strengths by the first pressure, the second pressure, and the third pressure are being exhibited respectively, a difference between the pressure sensitive adhesive strength by the first pressure and the pressure sensitive adhesive strength by the second pressure, and a difference between the pressure sensitive adhesive strength by the second pressure and the pressure sensitive adhesive strength by the third pressure are more reliably exhibited. In addition, in a case where T2/T1 is 3 or less, compared to a case where the ratio is greater than 3, haze is suppressed and sufficient transparency is more reliably exhibited.

The above-mentioned long pressure sensitive adhesive sheet member is produced by, for example, a production facility 30 for a pressure sensitive adhesive sheet member shown in FIG. 5 (hereinafter, referred to as a sheet member production facility). The sheet member production facility 30 includes a coating solution preparation device 31, a feeding device 32, a coating device 33, a drying device 36, and a winding device 37 in this order from the upstream side.

The coating solution preparation device 31 is provided for preparing a first coating solution 41 and a second coating solution 42. The first coating solution 41 forms the first pressure sensitive adhesive layer 12 and the second coating solution 42 forms the second pressure sensitive adhesive layer 13. The coating solution preparation device 31 may be provided outside the sheet member production facility 30 instead of inside the sheet member production facility 30. In this case, the first coating solution 41 and the second coating solution 42 prepared are temporarily stored in a storage container. The coating solution preparation device 31 is constituted of a first dissolving portion 45, a second dissolving portion 46, a mixing portion 47, and the like.

The first dissolving portion 45 performs heating and/or stirring on a first organopolysiloxane 48 to be supplied and a first solvent 51 which is a solvent for the first organopolysiloxane 48. Thus, a first coating solution 41 in which the first organopolysiloxane 48 is dissolved in the first solvent 51 is prepared.

The second dissolving portion 46 performs heating and/or stirring on a second organopolysiloxane 49 to be supplied and a second solvent 52 which is a solvent for the second organopolysiloxane 49. Thus, a pressure sensitive adhesive solution 53 in which the second organopolysiloxane 49 is dissolved in the second solvent 52 is prepared. The mixing portion 47 stirs a fine particle dispersion 54 to be supplied and the pressure sensitive adhesive solution 53 to prepare a second coating solution 42. The fine particle dispersion 54 is a solution in which the fine particles 18 are dispersed in a dispersion medium.

For the first organopolysiloxane 48 and the second organopolysiloxane 49, polydimethylsiloxanes are more preferable and among polydimethylsiloxanes, the above-mentioned curable polydimethylsiloxane is even more preferable.

As the curable polydimethylsiloxane, a peroxide curable polydimethylsiloxane and an addition reactive polydimethylsiloxane are preferable, and in the embodiment, an addition reactive polydimethylsiloxane is used. The peroxide curable polydimethylsiloxane is crosslinked through a condensation reaction by heating by using a crosslinking agent, and the above-mentioned peroxide curing type polydimethylsiloxane is formed through the crosslinking. As the crosslinking agent, for example, benzoyl peroxide or the like is preferable. The addition reactive polydimethylsiloxane has a vinylsilyl group (Si—CH═CH₂ group) and/or a hydrosilyl group (Si—H group) in the molecule and is crosslinked by heating using a catalyst. Through the crosslinking, the above-mentioned addition reaction type polydimethylsiloxane is formed. As the catalyst, for example, platinum or the like is preferably and in the embodiment, platinum is also used.

As the peroxide curable polydimethylsiloxane and the addition reactive polydimethylsiloxane, commercially available products as materials for the pressure sensitive adhesive may be used. Examples of the peroxide curable polydimethylsiloxane that can be used include KR-100, KR-130, and KR-101-10, manufactured by Shin-Etsu Chemical Co., Ltd., and SH-4280, manufactured by Dow Corning Toray Co., Ltd. Examples of the addition reactive polydimethylsiloxane that can be used include KR-3700, KR-3701, manufactured by Shin-Etsu Chemical Co., Ltd., and SD4580 and SD4584, manufactured by Dow Corning Toray Co., Ltd., and in the embodiment, SD4584 manufactured by Dow Corning Toray Co., Ltd. is used.

In a case where a flow of the first coating solution 41 and a flow of the second coating solution 42 are mixed in one coating die 58 and flow out from an outlet 58a as described later, the smaller a difference between the concentrations of solid contents of each coating solution is, the more preferable it is. It is more preferable that the concentrations of solid contents of each coating solution are the same. In the embodiment, the concentration of solid contents of the first coating solution 41 is the same as the concentration of solid contents of the second coating solution 42. The solid content refers to a substance constituting the pressure sensitive adhesive sheet member 62 among substances respectively constituting the first coating solution 41 and the second coating solution 42 or a component forming the substance. As the forming component, for example, there is a curable polydimethylsiloxane which forms a curing type polydimethylsiloxane.

The first organopolysiloxane 48 and the second organopolysiloxane 49 are sometimes commercially available in a state of a solution in which the first organopolysiloxane and the second organopolysiloxane are dissolved in the solvents. In this case, according to each target formulation for the first coating solution 41 and the second coating solution 42, the first solvent 51 and the second solvent 52 may not be used or each amount of these solvents may be increased or decreased. In addition, the first silicone-based pressure sensitive adhesive 15 may be used as the first organopolysiloxane 48 and the second silicone-based pressure sensitive adhesive 16 may be used as the second organopolysiloxane 49.

The feeding device 32 is provided for continuously feeding the sheet base material 11 from a base material roll 57 around which the long sheet base material 11 is wound. The feeding device 32 feeds the sheet base material 11 in such a manner that, for example, the base material roll 57 in which the sheet base material 11 is wound around a winding core 57a is set and the winding core 57a is rotated in a circumferential direction. The feeding speed of the sheet base material 11 (which is the same as the conveyance speed) is set to 10 m/min in the embodiment but is not limited thereto. The conveyance speed of the sheet base material 11 is almost the same as the feeding speed.

The coating device 33 is constituted of the coating die 58, a support roller 59, and the like. The support roller 59 supports the sheet base material 11 from below and is provided below the coating die 58. The coating die 58 is provided for continuously feeding the first coating solution 41 and the second coating solution 42. To the coating die 58, the first coating solution 41 and the second coating solution 42 are independently supplied. In the coating die 58, the flow of the first coating solution 41 and the flow of the second coating solution 42 are superimposed in layers through a flow path formed inside the coating die. In the coating die 58, the flow of the first coating solution 41 and the flow of the second coating solution 42 are superimposed such that the flow of the second coating solution is superimposed on the downstream of the flow of the first coating solution 41 in a conveyance direction of the sheet base material 11. In a state in which these flows are superimposed, the first coating solution 41 and the second coating solution 42 flow out from the outlet 58a, and then the first coating solution 41 is in contact with the sheet base material 11 to form a coating film 61 in which the second coating solution 42 is superimposed on the first coating solution 41 (coating step).

The drying device 36 is provided for drying the coating film 61 to obtain a pressure sensitive adhesive sheet member 62. In the embodiment, since the addition reactive polydimethylsiloxane which is crosslinked by heating is used as the first organopolysiloxane 48 and the second organopolysiloxane 49 as described above, the drying device 36 is also used as a crosslinking device for crosslinking the addition reactive polydimethylsiloxane by heating the coating film 61. The drying device 36 includes a plurality of rollers (not shown) which support the sheet base material 11 in which the coating film 61 is formed at the circumferential surface and a drying gas (for example, drying air) is supplied. The plurality of rollers include a driving roller for conveying the sheet base material 11 in which the coating film 61 is formed by being rotatably driven in the circumferential direction. The supplied drying gas is adjusted to have a predetermined temperature and a predetermined humidity and while the coating film 61 is being conveyed, drying is performed by the drying gas to form the pressure sensitive adhesive sheet member 62 (drying step). In the embodiment, by setting the temperature of the drying gas a temperature for heating the coating film 61, the first organopolysiloxane 48 included in the coating film 61 is crosslinked by the drying gas to form the first silicone-based pressure sensitive adhesive 15 and the second organopolysiloxane 49 is crosslinked by the drying gas to form the second silicone-based pressure sensitive adhesive 16 (crosslinking step). In the embodiment, the air at 100° C. is used as the drying gas but the drying gas is not limited thereto. The temperature and the kind of gas are appropriately set according to the kinds of the first organopolysiloxane 48, the second organopolysiloxane 49, and the fine particles 18 and the like. In addition, in the embodiment, the time for supplying the drying gas to the coating film 61 (the time for the drying step) is set to 3 minutes but is not limited thereto. The time for the drying step is appropriately set according to the kinds of the first organopolysiloxane 48, the second organopolysiloxane 49, and the fine particles 18, the amount of the first solvent 51 and the second solvent, and the like. The winding device 37 winds the pressure sensitive adhesive sheet member 62 around a winding core 63 in a roll shape and thus a pressure sensitive adhesive sheet member roll 64 including the winding core 63 and the pressure sensitive adhesive sheet member 62 is obtained.

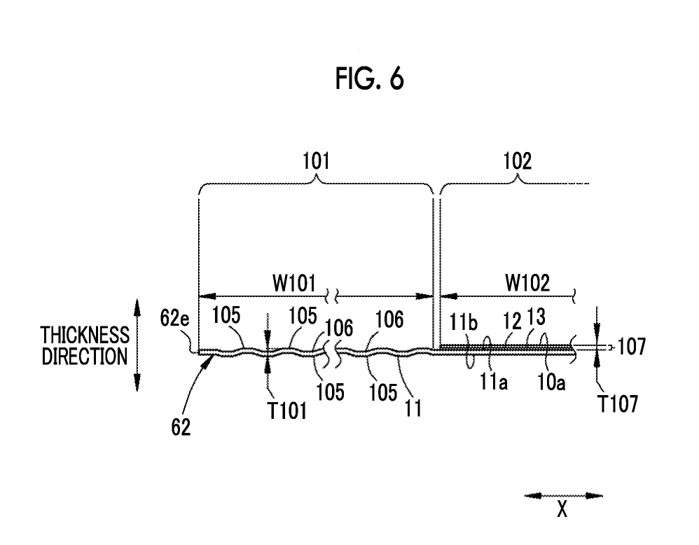

It is more preferable that the pressure sensitive adhesive sheet member 62 includes film thickness portions at each side end in a width direction as follows. In FIG. 6, the pressure sensitive adhesive sheet member 62 includes knurlings 101, as an example of the film thickness portion, at both side ends in a width direction X. Since one side end and the other side end have the same configuration, only one side end is shown in FIG. 6. The pressure sensitive adhesive sheet member 62 has a pressure sensitive adhesive portion 102 at the center between both knurlings 101 in the width direction X. The pressure sensitive adhesive portion 102 has the same configuration as the pressure sensitive adhesive sheet 10 (refer to FIG. 1), that is, the pressure sensitive adhesive portion is formed of the pressure sensitive adhesive sheet 10. In FIG. 6, in order to avoid complication of the drawing, the hatching indicating the cross section is not shown.

The width of the pressure sensitive adhesive sheet member 62 is not particularly limited and is set to in a range of, for example, 100 mm or more and 1500 mm or less. In the embodiment, the width is set to 200 mm. The length of the knurling 101 in the width direction X (hereinafter, referred to as knurling width) W101 is not particularly limited and is set to in a range of, for example, 5 mm or more and 50 mm or less. In the embodiment, the knurling width is set to 25 mm. The knurling width W101 is a distance from a side edge 62e of the pressure sensitive adhesive sheet member 62 to the inner side edge of the knurling 101 in the width direction X. The length of the pressure sensitive adhesive portion 102 in the width direction X (hereinafter, referred to as pressure sensitive adhesive portion width) W102 is not particularly limited and is set to in a range of, for example, 50 mm or more and 1000 mm or less. In the embodiment, the pressure sensitive adhesive portion width is set to 120 mm. The pressure sensitive adhesive portion width W102 is a distance from one side edge to the other side edge of the pressure sensitive adhesive portion 102 in the width direction X.

In the embodiment, the knurling 101 is formed of a sheet base material 11 having a plurality of projecting portions 105 on each of one base material surface 11a and the other base material surface 11b. Reference symbol 106 denotes a recessed portion between the projecting portions 105. In this example, the sheet base material 11 is a member for constituting both the knurling 101 and the pressure sensitive adhesive portion 102 and is formed to have a width larger than those of the first pressure sensitive adhesive layer 12 and the second pressure sensitive adhesive layer 13. The projecting portion 105 on one base material surface 11a and the recessed portion 106 on the other base material surface 11b have a front-rear relationship in which the projecting portion and the recessed portion are opposite to each other in the thickness direction, but the top portion of the projecting portion 105 and the valley portion of the recessed portion 106 may be slightly shifted in at least one of the width direction X or the longitudinal direction (in the depth direction of the paper plane in FIG. 6).

The shape of the projecting portion 105 and the recessed portion 106 in the embodiment is a truncated pyramid as the shape of a first knurling roller 121 and a second knurling roller 122, which will be described later. However, each of the projecting portion 105 and the recessed portion 106 is formed into, for example, a truncated pyramid according to the temperature of the first knurling roller 121 and the second knurling roller 122, and the pressing force pressing the pressure sensitive adhesive sheet member 62 by these rollers. In addition, by changing the shape of the protrusions of the first knurling roller 121 and the second knurling roller 122 to another shape, the projecting portion 105 and the recessed portion 106 may be formed into another shape. The distance between the projecting portion 105 and the projecting portion 105 in the width direction X (hereinafter, referred to as a projecting portion pitch) is not particularly limited. The distance is appropriately 1.5 mm and is constant in the embodiment. In FIG. 6, the projecting portion pitch is drawn such that the thickness of the sheet base material 11 and the pressure sensitive adhesive portion 102 is largely exaggerated.

Here, a laminated portion from one surface to the boundary between the first pressure sensitive adhesive layer 12 and the sheet base material 11 in the pressure sensitive adhesive portion 102 is referred to as a pressure sensitive adhesive laminate portion and reference symbol 107 is assigned thereto. Since the pressure sensitive adhesive portion 102 has the same configuration as the pressure sensitive adhesive sheet 10 (refer to FIG. 1) as described above, the “one surface” of the pressure sensitive adhesive portion 102 corresponds to the first sheet surface 10a of the pressure sensitive adhesive sheet 10 and thus reference symbol 10a is assigned thereto in FIG. 6. A distance between the top portion of the projecting portion 105 on one base material surface 11a in the knurling 101 and the top portion of the projecting portion 105 on the other base material surface lib in the thickness direction is set to a thickness T101 of the knurling 101. The thickness T101 of the knurling 101 is larger than a thickness T107 of the pressure sensitive adhesive laminate portion 107. Thus, for example, the pressure sensitive adhesive sheet member roll 64 more reliably prevents the superimposed pressure sensitive adhesive sheet members 62 from adhering during a long period of time for storage or transport. The thickness T101 may be 1.0 time larger than the thickness T107 and is more preferably at least 1.5 times, that is, 1.5 times or more larger than the thickness T107.

In the embodiment, the projecting portions 105 formed on one base material surface 11a are formed so as to protrude more than one base material surface 11a of the pressure sensitive adhesive portion 102, and the projecting portions 105 formed on the other base material surface 11a 11b are formed so as to protrude more than the other base material surface lib of the pressure sensitive adhesive portion 102. However, there is no limitation thereto. For example, the projecting portions 105 formed on one base material surface 11a may be formed to have the same height as the one base material surface 11a of the pressure sensitive adhesive portion 102 and the projecting portions 105 formed on the other base material surface 11b may be formed to have the same height as the other base material surface 11b of the pressure sensitive adhesive portion 102. In addition, in the embodiment, the projecting portions 105 are formed on both base material surfaces 11a and 11 b but may be formed any one of the both base material surfaces.

The film thickness portion is not limited to the knurling 101 and may be formed to be thicker than the pressure sensitive adhesive laminate portion 107 of the pressure sensitive adhesive portion 102 so that the second pressure sensitive adhesive layer 13 is not exposed from the surface, that is, in an unexposed state. For example, the film thickness portion may be a film thickness portion in which a tape material for providing thickness to each side end of at least one base material surface 11a of the sheet base material 11 is provided. Alternatively, the film thickness portion may be a film thickness portion in which the pressure sensitive adhesive laminate portion 107 is provided over the entire region of one base material surface 11a in the width direction X and a non-pressure sensitive adhesive protective layer is provided on the second pressure sensitive adhesive layer 13 (refer to FIG. 1) at each side end. In addition, each film thickness portion including the knurling 101 is not limited to the pressure sensitive adhesive sheet member 62 with the configuration in which the pressure sensitive adhesive portion 102 includes the pressure sensitive adhesive laminate portion 107 and can be provided to a pressure sensitive adhesive layer that does not require a release sheet or a long pressure sensitive adhesive sheet member including a pressure sensitive adhesive laminate portion. Thus, the sheet members are prevented from adhering to each other in a rolled state without using a release sheet.

In the pressure sensitive adhesive sheet member 62 including each film thickness portion such as the knurling 101, the pressure sensitive adhesive portion 102 can be cut into a sheet to form the pressure sensitive adhesive sheet 10. However, even in a state of the pressure sensitive adhesive sheet member roll 64, the sheets do not adhere to each other without a release sheet and thus can be stored or transported. In addition, the sheet member can be cut into a desired size and used in use.

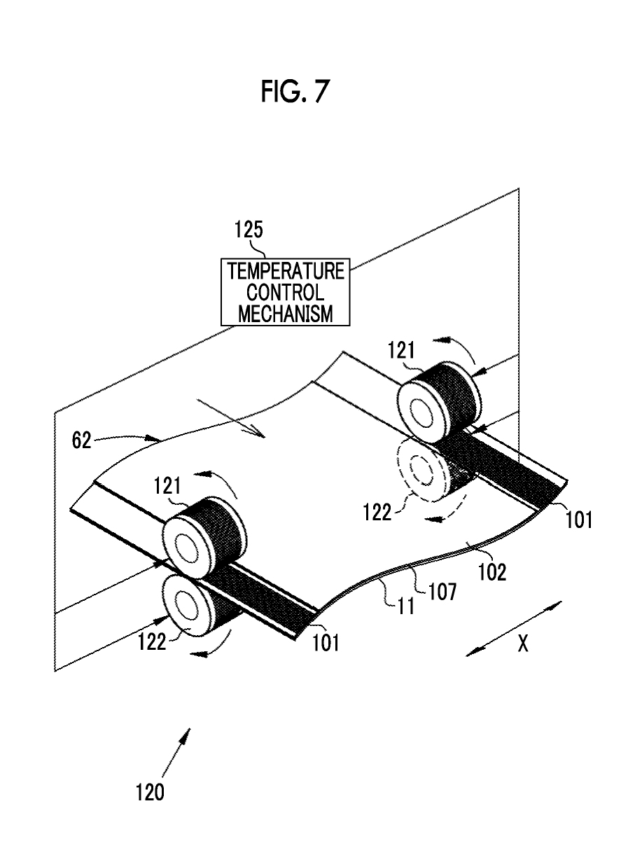

The knurling 101 can be formed by, for example, a knurling device 120 as a thickening device shown in FIG. 7. In the embodiment, in a case of producing the pressure sensitive adhesive sheet member 62 having the knurling 101, the sheet member production facility in which the knurling device 120 is provided between the drying device 36 (refer to FIG. 5) and the winding device 37 (refer to FIG. 5) is used in the production of the sheet member. The coating film is not formed at both side ends of the long sheet base material 11 and is formed only at the center between one side end and the other side end in the width direction X (refer to FIG. 6) by the above-mentioned coating device 33. However, the knurling 101 may be formed by obtaining the pressure sensitive adhesive sheet member 62 without the knurling 101 by the sheet member production facility 30 (refer to FIG. 5), feeding the pressure sensitive adhesive sheet member 62 from the obtained pressure sensitive adhesive sheet member roll 64 to the knurling device 120 by the feeding device, and providing the knurling 101 to both side ends of the sheet base material 11. In this case, the coating film is also formed only at the center between the one side end and the other side end in the width direction X.

In the embodiment, since the knurling 101 is provided at both side ends of the pressure sensitive adhesive sheet member 62, the knurling device 120 includes two pairs of rollers consisting of the first knurling roller 121 and the second knurling roller 122 as shown in FIG. 7. The pairs of rollers are disposed in a passing region through which each side end of the pressure sensitive adhesive sheet member 62 pass in the conveyance path of the pressure sensitive adhesive sheet member 62.

The knurling device 120 includes a temperature control mechanism 125 and the temperature control mechanism 125 controls the temperature of the circumferential surface of each of the first knurling roller 121 and the second knurling roller 122 by controlling heaters respectively embedded in the first knurling roller 121 and the second knurling roller 122 (not shown).

The paired first knurling roller 121 and the second knurling roller 122 are provided to be opposite to each other in such a posture that the rotation axis are parallel with each other and be freely rotatable, and cooperate to provide the knurling 101 to the pressure sensitive adhesive sheet member 62.

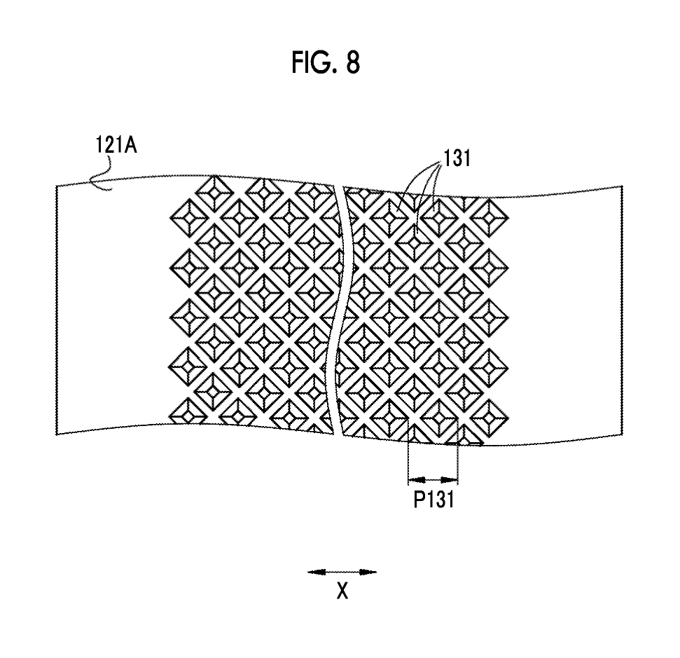

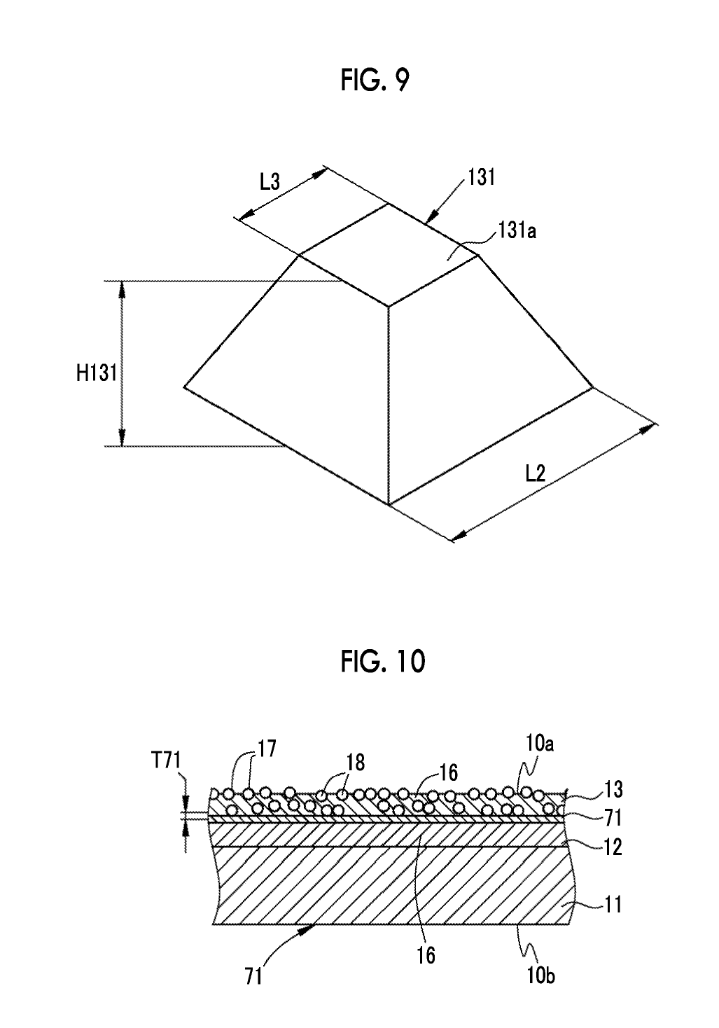

Since the circumferential surfaces of the first knurling roller 121 and the second knurling roller 122 have the same configuration, a circumferential surface 121A of the first knurling roller 121 will be described in detail using FIGS. 8 and 9, and the description of the circumferential surface of the second knurling roller 122 is omitted. As shown in FIG. 8, a plurality of protrusions (knurling teeth) 131 are formed on the circumferential surface of the first knurling roller 121 for providing the knurling 101 to the pressure sensitive adhesive sheet member 62. As shown in FIG. 9, the protrusion 131 in the embodiment has a truncated pyramid, more specifically, a truncated square pyramid. A large number of the plurality of protrusions 131 are formed in a matrix shape but the plurality of protrusions 131 may be squarely arranged. In the embodiment, a protrusion group having 15 lines of protrusions which is the number in the width direction X are arranged and a protrusion group having 16 lines of protrusions are arranged are alternately arrayed in the circumferential direction (in the vertical direction of the paper plane). A pitch P131 of the protrusion 131 in the width direction X is preferably in a range of 1.0 mm or more and 3.0 mm or less.

In FIG. 9, a height H131 of the protrusion 131 is 0.5 mm, a length L2 of one side of a bottom surface is 0.5 mm, a length L3 of one side of an upper surface 131a is 0.2 mm. The height H131 of the protrusion 131 is preferably in a range of 0.1 mm or more and 1.0 mm or less, the length L2 is preferably in a range of 0.1 mm or more and 1.0 mm or less, and the length L3 is preferably in a range of 0.05 mm or more and 0.5 mm or less. The shape of the protrusion 131 is not limited to the truncated pyramid and a truncated cone shape or other shapes may be adopted.

The first knurling roller 121 and the second knurling roller 122 are provided such that the protrusions 131 of the first knurling roller 121 and recesses between the protrusions 131 of the second knurling roller 122 are opposite to each other. In a state in which the pressure sensitive adhesive sheet member 62 is interposed between the first knurling roller 121 and the second knurling roller 122, the first knurling roller 121 and the second knurling roller 122 are rotated by a motor (not shown). The conveyance direction of the pressure sensitive adhesive sheet member 62, that is, the rotation direction of the first knurling roller 121 is a counterclockwise direction in FIG. 7 and the rotation direction of the second knurling roller 122 is a clockwise direction in FIG. 7. These first knurling roller 121 and second knurling roller 122 press the pressure sensitive adhesive sheet member 62 during conveyance in the thickness direction and thus the knurling 101 is continuously formed on the pressure sensitive adhesive sheet member 62 (a knurling providing step as a thickening step).

The pressing force pressing the pressure sensitive adhesive sheet member 62 by the first knurling roller 121 and the second knurling roller 122 is set to 17 MPa in the embodiment but is not limited thereto. The pressing force may be appropriately adjusted according to the thickness and the temperature of the sheet base material 11. The temperature of the circumferential surface of each of the first knurling roller 121 and the second knurling roller 122 is adjusted to 90° C. by the temperature control mechanism 125 in the embodiment but the temperature is not limited thereto. For example, the temperature is preferably in a range of 70° C. or higher and 200° C. or lower. In this example, the thickening step is performed after coating step but is not limited thereto. The thickening step may be performed before the coating step. That is, the coating step may be performed after the sheet base material 11 is fed for the thickening step.

In FIG. 10, a pressure sensitive adhesive sheet 70 includes a sheet base material 11, a first pressure sensitive adhesive layer 12 that is disposed on one base material surface of the sheet base material 11, and a second pressure sensitive adhesive layer 13 that is provided on the first pressure sensitive adhesive layer 12 through a mixed layer 71. In FIG. 10, the same reference symbols as in FIG. 1 are assigned to the same members as in FIG. 1 and the description thereof is omitted.

As described above, the mixed layer 71 is provided between the first pressure sensitive adhesive layer 12 and the second pressure sensitive adhesive layer 13 in the pressure sensitive adhesive sheet 70. The mixed layer 71 is provided for further enhancing adhesion between the first pressure sensitive adhesive layer 12 and the second pressure sensitive adhesive layer 13.

In the mixed layer 71, the first silicone-based pressure sensitive adhesive 15 and the second silicone-based pressure sensitive adhesive 16 are mixed. The boundary between the mixed layer 71 and the second pressure sensitive adhesive layer 13 is confirmed with the boundary of the presence or absence of the fine particles 18 in the thickness direction in the example. In a case where the first silicone-based pressure sensitive adhesive 15 and the second silicone-based pressure sensitive adhesive 16 are different substances from each other, the boundary between the mixed layer 71 and the second pressure sensitive adhesive layer 13 can be confirmed with the boundary of the presence or absence of the fine particles as described above, and can be confirmed by performing element analysis with a time-of-flight secondary ion mass spectrometer (hereinafter, abbreviated as TOF-SIMS) and a scanning electron microscope-energy dispersive X-ray detector (hereinafter, abbreviated as SEM-EDX). In addition, in the example, the boundary between the mixed layer 71 and the first pressure sensitive adhesive layer 12 is confirmed by mixing and coloring any one of the first coating solution 41 or the second coating solution 42 prepared as described above with a dye, preparing a pressure sensitive adhesive sheet in the same manner as in the case of the pressure sensitive adhesive sheet 10 using the solution, and observing the cross section thereof. In the case where the first silicone-based pressure sensitive adhesive 15 and the second silicone-based pressure sensitive adhesive 16 are different substances from each other, the boundary between the mixed layer 71 and the first pressure sensitive adhesive layer 12 can be also confirmed by performing element analysis with a TOF-SIMS and a SEM-EDX, or observing the cross section with a scanning electron microscope (SEM) and a transmission electron microscope (TEM).

As is well-known, the TOF-SIMS is one device for performing secondary ion mass spectrometry (SIMS) by irradiating a sample which is an object to be analyzed with a primary ion beam, and detecting ions (secondary ions) emitted from the surface of the sample at the irradiation. For the spectrometry, for example, a sample sampled from the pressure sensitive adhesive sheet which is an object to be analyzed is embedded in an epoxy resin. The sample in the embedded state is cut using a microtome to be inclined to the sheet surface of the pressure sensitive adhesive sheet at an angle of, for example, about 15 degrees, and the inside of the sample is exposed to the surface to expose an analysis surface. The primary ions are emitted to the analysis surface whose surface is exposed. As a mass spectrometer, a time-of-flight mass spectrometer (TOF-MS) is used. At the time of performing TOF-SIMS, a TOF-SIMS 5 manufactured by ION-TOF Inc., a Bi3⁺ primary ion gun, and the like can be used.

The mixed layer 71 is formed such that the first silicone-based pressure sensitive adhesive 15 included in the first coating solution 41 and the second silicone-based pressure sensitive adhesive 16 included in the second coating solution 42 are mutually diffused in the coating film 61. Therefore, the amount of the first silicone-based pressure sensitive adhesive 15 in the mixed layer 71 is gradually reduced from the first pressure sensitive adhesive layer 12 to the second pressure sensitive adhesive layer 13 and the reduction is continuous. In addition, the amount of the second silicone-based pressure sensitive adhesive 16 in the mixed layer 71 is gradually increased from the first pressure sensitive adhesive layer 12 to the second pressure sensitive adhesive layer 13 and the increase is continuous. Due to the distribution of the first silicone-based pressure sensitive adhesive 15 and the second silicone-based pressure sensitive adhesive 16 in the thickness direction, the adhesion between the first pressure sensitive adhesive layer 12 and the second pressure sensitive adhesive layer 13 is more reliably enhanced.

A thickness T71 of the mixed layer 71 is preferably set to at least 0.5 μm and is set to 1.0 μm in the embodiment. By setting the thickness T71 to at least 0.5 μm, the adhesion between the first pressure sensitive adhesive layer 12 and the second pressure sensitive adhesive layer 13 is reliably enhanced and for example, even in a case where the pressure sensitive adhesive sheet 70 is peeled off from an adherend at the time of re-adherence in the preparation case and/or after a long period of time of adherence, the first pressure sensitive adhesive layer 12 and the second pressure sensitive adhesive layer 13 are integrally peeled off from the adherend. The thickness T71 is more preferably in a range of 0.5 μm or more and 3.0 μm or less, even more preferably in a range of 0.5 μm or more and 2.0 μm or less, and particularly preferably in a range of 0.5 μm or more and 1.5 μm or less.

The mass ratio of the first silicone-based pressure sensitive adhesive 15 in the mixed layer 71 is preferably in a range of 10% by mass or more and 50% by mass or less. The mass ratio is a percentage obtained by (M15/M71)×100 in a case where the mass of the mixed layer 71 is set to M71, the mass of the first silicone-based pressure sensitive adhesive is set to M15, and the units of M71 and M15 are the same. In a case where the mass ratio of the first silicone-based pressure sensitive adhesive 15 in the mixed layer 71 is 10% by mass or more, compared to a case where the mass ratio of the first silicone-based pressure sensitive adhesive is less than 10% by mass, the adhesion between the first pressure sensitive adhesive layer 12 and the second pressure sensitive adhesive layer 13 is further enhanced. In addition, in a case where the mass ratio of the first silicone-based pressure sensitive adhesive 15 in the mixed layer 71 is 50% by mass or less, compared to a case where the mass ratio of the first silicone-based pressure sensitive adhesive is more than 50% by mass, the adhesion between the first pressure sensitive adhesive layer 12 and the second pressure sensitive adhesive layer 13 is further enhanced.

The pressure sensitive adhesive sheet 70 is prepared by cutting out the long pressure sensitive adhesive sheet member (not shown) produced by using the above-mentioned sheet member production facility 30 into a sheet. In order to form the mixed layer 71, a difference between the proportion of the first solvent 51 in the first coating solution 41 and the proportion of the second solvent 52 in the second coating solution 42 is generated. Thus, the first organopolysiloxane 48 and the second organopolysiloxane 49 are more reliably diffused in the coating film 61. However, the difference between the proportion of the first solvent 51 in the first coating solution 41 and the proportion of the second solvent 52 in the second coating solution 42 is preferably in a range of more than 0% and less than 15%. In a case where the difference is less than 15%, compared to a case where the difference is 15% or more, rapid diffusion of the first solvent 5I and the second solvent 52 is suppressed at the boundary between the first coating solution 41 and the second coating solution 42 of the coating film 61. Gelation at the boundary by the rapid diffusion is suppressed. The difference between the proportion of the first solvent 51 in the first coating solution 41 and the proportion of the second solvent 52 in the second coating solution 42 is more preferably in a range of 3% or more and less than 15% and even more preferably 10% or more and less than 15%.

The proportion of the first solvent 51 (unit: %) in the first coating solution 41 is obtained by (M51/M41)×100 in a case where the mass of the first coating solution is set to M41 and the mass of the first solvent 51 is set to M51, and the proportion (unit: %) of the second solvent 52 in the second coating solution 42 is obtained by (M52/M42)×100 in a case where the mass of the second coating solution 42 is set to M42 and the mass of the second solvent 52 is set to M52. The difference between the proportion of the first solvent 51 in the first coating solution 41 and the proportion of the second solvent 52 in the second coating solution 42 is obtained by |(M51/M41)×100-(M52/M42)×100|.

In a case where the pressure sensitive adhesive sheet 70 is produced, it is preferable that the first drying speed is lower than the second drying speed in the drying device 36 during the drying step. Thus, the first organopolysiloxane 48 and the second organopolysiloxane 49 are more reliably diffused in the coating film 61.

In a case where the pressure sensitive adhesive sheet member having the knurling 101 is produced, in the example, the knurling 101 may be provided to the side ends of the sheet base material 11 by forming the coating film only at the center in the width direction X.

Hereinafter, Examples of the present invention and Comparative Examples with respect to the present invention will be described.

### EXAMPLES

### [Example 1] to [Example 9]

Nine kinds of pressure sensitive adhesive sheet members 62 having coverage ratios RC shown in Table 1 were produced by the sheet member production facility 30 using the fine particles 18 having average particle diameters shown in Table 1. Each of these pressure sensitive adhesive sheet members was cut into a rectangular shape to obtain each pressure sensitive adhesive sheet 10. The obtained pressure sensitive adhesive sheets were used for Examples 1 to 9. To an addition reaction type silicone-based pressure sensitive adhesive (SD4584, manufactured by Dow Corning Toray Co., Ltd., having a concentration of solid contents of 60% by mass), 1% by mass of a platinum catalyst (NC-25 CATALYST, manufactured by Dow Corning Toray Co., Ltd.) was added and toluene as the first solvent 51 was further added. Thus, a first coating solution 41 having a concentration of solid contents of 40% by mass was prepared. The fine particles 18 and toluene as the second solvent 52 were added to the first coating solution 41 such that the ratio of the fine particles 18 with respect to the solid contents was 25% by mass, and thus a second coating solution 42 having a concentration of solid contents of 40% by mass was prepared. As the fine particles 18, fine particles consisting of silicone were used.

The feeding speed of the sheet base material 11 was set to 10 m/min. The first coating solution 41 and the second coating solution 42 were applied using the coating die 58 such that the thickness of the first pressure sensitive adhesive layer 12 was 20 μm and the thickness of the second pressure sensitive adhesive layer 13 was 20 μm in the pressure sensitive adhesive sheet member 62. For crosslinking of each of the first organopolysiloxane 48 and the second organopolysiloxane 49 and evaporation of the first solvent 51 and the second solvent 52, the temperature of the drying gas in the drying device 36 was set to 100° C. and the sheet base material was allowed to pass through the drying device 36 to dry and heat the coating film 61.

With respect to each of the obtained pressure sensitive adhesive sheets 10, the pressure sensitive adhesive performance in a before-use case and transparency were evaluated.

Evaluation 1. Pressure Sensitive Adhesive Performance in Before-Use Case (Pressure Sensitive Adhesive Performance 1)

For the pressure sensitive adhesive performance in the before-use case, the first pressure, that is, a pressure of 1 N/cm² was applied and the pressure sensitive adhesive strength in a case where the first pressure was applied was obtained by the above-mentioned method and evaluated based on the following standards. A to C are “pass” levels and D is a “fail” level. The evaluation results are shown in the column of “Pressure sensitive adhesive performance 1” in Table 1.

A: The pressure sensitive adhesive strength is 0.00 N/25 mm.

B: The pressure sensitive adhesive strength is in a range greater than 0.00 N/25 mm and 0.04 N/25 mm or less.

C: The pressure sensitive adhesive strength is in a range of greater than 0.04 N/25 mm and 0.44 N/25 mm or less.

D: The pressure sensitive adhesive strength is greater than 0.44 N/25 mm.

Evaluation 2. Transparency

The haze of each of the pressure sensitive adhesive sheets 10 was obtained and the transparency was evaluated based on the haze. The haze was calculated from the proportion of transmitted and diffused light with respect to total transmitted light by the method in accordance with JIS-K-7136. A to C are “pass” levels and D is a “fail” level. The evaluation results are shown in the column of “Haze” in Table 1.

A: Less than 5%

B: In a range of more than 5% and 10% or less

C: In a range of more than 10% and 30% or less

D: More than 30%

TABLE 1

| | | | Pressure | |
|---|---|---|---|---|
| | Average | Coverage | sensitive | |
| | particle | ratio | adhesive | |
| | diameter | RC | perfor- | |
| | (μm) | (%) | mance 1 | Haze |
| Example 1 | 2 | 10 | C | A |
| Example 2 | 2 | 40 | B | B |
| Example 3 | 2 | 70 | A | C |
| Example 4 | 6 | 10 | C | A |
| Example 5 | 6 | 40 | B | B |
| Example 6 | 6 | 70 | A | C |
| Example 7 | 15 | 10 | C | A |
| Example 8 | 15 | 40 | B | B |
| Example 9 | 15 | 70 | A | C |
| Comparative | 2 | 8 | D | A |
| Example 1 | | | | |
| Comparative | 2 | 71 | A | D |
| Example 2 | | | | |
| Comparative | 6 | 8 | D | A |
| Example 3 | | | | |
| Comparative | 6 | 71 | A | D |
| Example 4 | | | | |
| Comparative | 15 | 8 | D | A |
| Example 5 | | | | |
| Comparative | 15 | 71 | A | D |
| Example 6 | | | | |
| Comparative | 1 | 10 | D | A |
| Example 7 | | | | |
| Comparative | 18 | 70 | A | D |
| Example 8 | | | | |

### [Example 10] to [Example 15]

The thickness of the first pressure sensitive adhesive layer 12 and the thickness of the second pressure sensitive adhesive layer 13 of Example 7 were changed to each thickness shown in Table 2 to obtain pressure sensitive adhesive sheet members for Examples 10 and 11. The thickness of the first pressure sensitive adhesive layer 12 and the thickness of the second pressure sensitive adhesive layer 13 of Example 8 were changed to each thickness shown in Table 2 to obtain pressure sensitive adhesive sheet members for Examples 12 and 13. The thickness of the first pressure sensitive adhesive layer 12 and the thickness of the second pressure sensitive adhesive layer 13 of Example 9 were changed to each thickness shown in Table 2 to obtain pressure sensitive adhesive sheet members for Examples 14 and 15.

With respect to the pressure sensitive adhesive sheets 10 obtained in Examples 10 to 15, in addition to the evaluation of the pressure sensitive adhesive performance in a before-use case and the haze, the pressure sensitive adhesive performance in a preparation case was evaluated based on the following standards. In addition, with respect to the pressure sensitive adhesive sheets 10 obtained in Examples 7 to 9, the pressure sensitive adhesive performance in a preparation case was evaluated in the same manner. The evaluation results of the before-use case are shown in the column of “Pressure sensitive adhesive performance 2” in Table 2.

Evaluation 3. Pressure Sensitive Adhesive Performance in Preparation Case (Pressure Sensitive Adhesive Performance 2)

For the pressure sensitive adhesive performance in the preparation case, a pressure of 1.2 N/cm² corresponding to the second pressure was applied and the pressure sensitive adhesive strength in this case was obtained by the above-mentioned method and evaluated based on the following standards. All A, B, and C are “pass” levels. B is more preferable than C and A is even more preferable than B.

A: In a range of 1.00 N/25 mm or greater and 2.00 N/25 mm or less

B: In a range of greater than 2.00 N/25 mm and 3.00 N/25 mm or less

C: Greater than 3.00 N/25 mm

TABLE 2

| | Thickness | Thickness | | | |
|---|---|---|---|---|---|
| | of first | of second | Pressure | Pressure | |
| | pressure | pressure | sensitive | sensitive | |
| | sensitive | sensitive | adhesive | adhesive | |
| | adhesive | adhesive | perfor- | perfor- | |
| | layer (μm) | layer (μm) | mance 1 | mance 2 | Haze |
| Example 7 | 20 | 20 | C | A | A |
| Example 10 | 30 | 10 | C | B | A |
| Example 11 | 35 | 5 | C | C | A |
| Example 8 | 20 | 20 | B | A | B |
| Example 12 | 30 | 10 | B | B | B |
| Example 13 | 35 | 5 | C | C | A |
| Example 9 | 20 | 20 | A | A | C |
| Example 14 | 30 | 10 | B | B | B |
| Example 15 | 35 | 5 | B | C | B |

### [Comparative Example 1] to [Comparative Example 8]

Eight kinds of pressure sensitive adhesive sheets having different average particle diameters of fine particles and coverage ratios RC were prepared and used for Comparative Examples 1 to 8.

In the same manner and based on the same standards as in Examples 1 to 9, the pressure sensitive adhesive performance in the use case and the transparency were evaluated.

The results are shown in Table 1.

### [Example 16] to [Example 19]

The coating film 61 was formed only at the center of the long sheet base material 11 and then the knurling 101 was formed at both side ends of the sheet base material 11 by the knurling device 120. Thus, pressure sensitive adhesive sheet members 62 having the knurlings 101 with different thicknesses T101 were produced and were used for Examples 16 to 19. The thickness T101 of each knurling 101 is shown in Table 3. The width of each pressure sensitive adhesive sheet member 62 is 200 mm and the length thereof is 50 m. The pressure sensitive adhesive sheet member 62 was wound around the winding core 63 to form the pressure sensitive adhesive sheet member roll 64. Other conditions to obtain the pressure sensitive adhesive sheet members 62 are the same as in Example 1.

The pressure sensitive adhesive sheet member roll 64 was left to stand for two days under the environment at a temperature of 25° C. and a relative humidity of 60% in a state in which the width direction X was horizontally set. After being left to stand, the pressure sensitive adhesive sheet member roll 64 was unwound and regarding a sheet member region of 0.012 m in a range of the pressure sensitive adhesive sheet member 62 between 0.04 m and 0.052 m from the unwound distal end, a degree of adherence was evaluated. The evaluation is performed based on the following standards and the evaluation results are shown in Table 3. A to D are “pass” levels and E is a “fail” level.

A: There was no adherence in the sheet member region.

B: Adherence was confirmed in an area of less than 5% of the sheet member region.

C: Adherence was confirmed in an area of 5% or more and less than 25% of the sheet member region.

D: Adherence was confirmed in an area of 25% or more and less than 50% of the sheet member region.

E: Adherence was confirmed in an area of 50% or more of the sheet member region.

TABLE 3

| | Thickness T101 of knurling | |
|---|---|---|
| | (μm) | Evaluation result |
| Example 16 | 80 | A |
| Example 17 | 60 | B |
| Example 18 | 40 | C |
| Example 19 | 30 | D |

What is claimed is:

1. A pressure sensitive adhesive sheet comprising:
a transparent sheet base material;
a first pressure sensitive adhesive layer that is provided on the sheet base material and includes a first silicone-based pressure sensitive adhesive; and
a second pressure sensitive adhesive layer that forms one sheet surface with the first pressure sensitive adhesive layer being held between the sheet base material and the second pressure sensitive adhesive layer, and has a second silicone-based pressure sensitive adhesive and a plurality of protrusions formed of a plurality of fine particles,
wherein the fine particles have an average particle diameter in a range of 2 μm or more and 15 μm or less,
a coverage ratio of the one sheet surface with the fine particles is in a range of 10% or more and 70% or less, and
a pressure sensitive adhesive strength at the one sheet surface is 0 N/25 mm at a pressure of 1 N/cm² or less.

2. The pressure sensitive adhesive sheet according to claim 1,
wherein the first pressure sensitive adhesive layer does not contain fine particles.

3. The pressure sensitive adhesive sheet according to claim 1,
wherein the first silicone-based pressure sensitive adhesive and the second silicone-based pressure sensitive adhesive are polydimethylsiloxanes.

4. The pressure sensitive adhesive sheet according to claim 1,
wherein a difference between a refractive index of the fine particle and a refractive index of the second silicone-based pressure sensitive adhesive is in a range of greater than 0 and 0.1 or less.

5. The pressure sensitive adhesive sheet according to claim 1,
wherein a ratio T2/T1 of a thickness T2 of the second pressure sensitive adhesive layer with respect to a thickness T1 of the first pressure sensitive adhesive layer is in a range of 0.1 or more and 3 or less.

6. The pressure sensitive adhesive sheet according to claim 1, further comprising:
a mixed layer provided between the first pressure sensitive adhesive layer and the second pressure sensitive adhesive layer, the first silicone-based pressure sensitive adhesive and the second silicone-based pressure sensitive adhesive being mixed in the mixed layer.

7. The pressure sensitive adhesive sheet according to claim 6,
wherein a thickness of the mixed layer is at least 0.5 μm.

8. The pressure sensitive adhesive sheet according to claim 6,
wherein a mass ratio of the first silicone-based pressure sensitive adhesive in the mixed layer is in a range of 10% by mass or more and 50% by mass or less.

9. A pressure sensitive adhesive sheet member which is long, comprising:
a pressure sensitive adhesive portion that is provided at a center in a width direction and is formed of the pressure sensitive adhesive sheet according to claim 1; and
a pair of film thickness portions that are provided at side ends in the width direction and have a thickness larger than a thickness from the one sheet surface in the pressure sensitive adhesive portion to a boundary between the first pressure sensitive adhesive layer and the sheet base material.

10. A method for producing a pressure sensitive adhesive sheet comprising:
a coating step of applying a first coating solution including a first organopolysiloxane and a solvent for the first organopolysiloxane, and a second coating solution including a second organopolysiloxane, a solvent for the second organopolysiloxane, and a plurality of fine particles having an average particle diameter in a range of 2 μm or more and 15 μm or less to a transparent sheet base material such that a flow of the first coating solution and a flow of the second coating solution are superimposed to form a coating film in which the second coating solution is superimposed on the first coating solution; and
a drying step of drying the coating film.

11. The method for producing a pressure sensitive adhesive sheet according to claim 10,
wherein the first organopolysiloxane and the second organopolysiloxane are curable polydimethylsiloxanes that are crosslinked by heating, and
the drying step includes a crosslinking step of respectively crosslinking the first organopolysiloxane and the second organopolysiloxane by heating the coating film.

12. The method for producing a pressure sensitive adhesive sheet according to claim 10,
wherein there is a difference between a proportion of the solvent in the first coating solution and a proportion of the solvent in the second coating solution.
